(19) United States
(12) Patent Application Publication
(10) Pub. No.: US 2024/0325920 A1
(43) Pub. Date: Oct. 3, 2024

(54) System, Method, and Computer Program Product for Enhancing Game Viewers' User-Experience by Augmenting Interactivity

(71) Applicant: TWIGO.TV LTD., Herzliya (IL)

(72) Inventors: Sol TZVI, Herzliya (IL); Omer DUSKIN, Petah Tikva (IL)

(21) Appl. No.: 18/624,772

(22) Filed: Apr. 2, 2024

Related U.S. Application Data
(60) Provisional application No. 63/493,854, filed on Apr. 3, 2023.

(51) Int. Cl. A63F 13/60; A63F 13/31; H04N 21/2187

(52) U.S. Cl. CPC A63F 13/60; A63F 13/31; H04N 21/2187

(57) ABSTRACT

Platform apparatus operative in conjunction with legacy games, the apparatus comprising a back-end server comprising a hardware processor which, responsive to at least one control parameter, changes at least one attribute, respectively, of at least one legacy game, in real-time or near realtime; and/or a user interface configured to present options for changing the at least one attribute to end-users viewing the legacy game being played by player/s other than the end-users; and/or accept inputs aka requests, from at least one of the end-users aka viewers, which select a subset of the options and/or, e.g. responsively to the inputs, supply control parameters to the back-end server, to yield a platform configured to apply end-user selected options for changing the at least one attribute, to the at least one legacy game.

### FIELD OF THIS DISCLOSURE

The present invention relates generally to games, and more particularly to video games.

### BACKGROUND

A wide variety of video games is known. For example, Minecraft is a well-known video game, whose code is in Java programming language.

Modding of Minecraft is known. Modding programmers may use available application program interfaces to yield downloadable modifications, texture packs, and custom maps for Minecraft. Modifications (aka mods) of the Minecraft code add gameplay changes, e.g., new blocks, items, and mods. Known mods that enhance gameplay include minimaps, waypoints, and durability counters. Other mods add elements from other video games and media to the original Minecraft. Mojang has provided frameworks for modification, which allow community-created resource packs, which alter certain game elements such as textures and sounds, to be created. Other mods include “maps” e.g., custom world save files created by players which may provide new rules, challenges, puzzles, or quests, and may be shared with other players.

Mojang has added an adventure mode as well as “command blocks” for custom maps in Java Edition. Data packs in version 1.13 of the Java Edition has provided new advancements, dimensions, functions, loot tables, predicates, recipes, structures, tags, world generation settings, and biomes.

Many Esport games have been developed. Examples of such legacy esport games are described here: www.rookieroad.com/esports/top-10-esports-games/

Some esport games enable developers to interface with an existing body of code, including an Esport game, so as to develop around the game.

Interactive gaming is known, e.g., Wild4Games.

Interactive video is known and is described e.g., here:
mipblog.com/2014/04/yoni-bloch-interlude-interactive-video-miptv/

Mods for video games are known e.g., as described here: gamerant.com/games-with-the-best-mods-ranked/#portal-2-ndash-portal-stories-mel

Many Minecraft mods are known, e.g., as described here:
www.pcgamesn.com/minecraft/twenty-best-minecraft-mods.

An API for GTA5 is described here: developer.toornament.com/v2/core-concepts/disciplines/gta5.

GTA5 mods are known and are presented here: www.gta5modhub.com/tag/api/. The following Wikipedia entry en.wikipedia.org/wiki/Grand Theft Auto modding describes GTA modding generally.

For example, a weapon limits adjuster mod is described here: www.gta5-mods.com/tools/cweaponinfoblob-limit-adjuster.

FiveM is a known mod for GTA5 which is described here: fivem.net/.

Known Roblox games (aka “experiences”) are listed here:
en.wikipedia.org/wiki/List_of_Roblox_games.

Live engagement between a live stream and viewers thereof is known, e.g., as presented here: www.playstream.gg/

The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a system which interacts with viewers of games and enables the viewers to change a game e.g., to provide a control input to a game server e.g., by providing an interface via which viewers are empowered to change at least one input parameter to a game server.

Optionally, the system may be integrated with a platform that enable users to view multiple live streams in a split screen, e.g., by adding a layer that presents viewers with input options such as buttons to modify a live stream they are viewing of a legacy game, typically via an API (application programming interface) to the legacy game server.

Certain embodiments seek to provide gaming platform apparatus operative in conjunction with a legacy game having at least one legacy modding tool, the apparatus comprising at least one gaming channel and/or a user interface presenting plural modding options implemented by plural modding tools to a user, and accepting from at least one user a selected modding option from among the plural modding options; and/or a processor configured to change the game software in accordance with the selected modding option.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth. There is thus provided, in accordance with at least one embodiment of the present invention,

The present invention typically includes at least the following embodiments:

Embodiment 1. Platform apparatus operative in conjunction with legacy games, the apparatus comprising:
a back-end server comprising a hardware processor which, responsive to at least one control parameter, changes at least one attribute, respectively, of at least one legacy game, in real-time or near realtime; and
a user interface which is configured to
   present options for changing the at least one attribute to end-users viewing the legacy game being played by player/s other than the end-users;
   accept inputs aka requests, from at least one of the end-users aka viewers, which select a subset of the options and,
   responsively to the inputs, supply control parameters to the back-end server,
thereby to yield a platform configured to apply end-user selected options for changing the at least one attribute, to the at least one legacy game.

Typically, the legacy game (which may be multiplayer or single player) has at least one modding tool aka mod which is configured to modify the game's code by changing individual game attribute/s. The options may be presented to the viewers as virtual buttons e.g. as an overlay of interaction buttons aka action buttons and each individual button corresponds to an individual one of the game attributes which the modding tool/s are configured to modify. The modding tool which knows how to change game attribute x by suitably modifying the game's code is typically activated to change game attribute x, when a viewer selects e.g. clicks on the button corresponding to game attribute x.

Embodiment 2. Apparatus according to any of the preceding embodiments and wherein each of the options comprises a game update effected by a legacy modding tool which is associated with the legacy game, and which is configured to modify the legacy game's code, and wherein the game update to be effected by the modding tool is selected by the platform apparatus responsive to a request from an end-user.

Embodiment 3. Apparatus according to any of the preceding embodiments and wherein the options for changing are presented to the end-users, while they are viewing the legacy game being played.

Embodiment 4. Apparatus according to any of the preceding embodiments and wherein the options are presented as an overlay of interaction buttons where each individual button corresponds to an individual option for changing an attribute of the game.

Embodiment 5. Apparatus according to any of the preceding embodiments and wherein a duration is defined for each option selected via the user interface, during which no other change request is accepted from any viewer.

Embodiment 6. Apparatus according to any of the preceding embodiments and wherein, once an option for changing the game has been effected and the duration defined for the option has lapsed, only a single end-user is entitled to select a next option to be effected.

Embodiment 7. Apparatus according to any of the preceding embodiments and wherein the single end-user is an end-user from among the end-users who selected a next option after the duration defined for the option lapsed and before any other end-user selected a next option.

Embodiment 8. Apparatus according to any of the preceding embodiments and wherein the single end-user is an end-user from among the end-users who bid higher than other end-users, to select the next option.

Embodiment 9. Apparatus according to any of the preceding embodiments and wherein the legacy game comprises a video game.

Embodiment 10. Apparatus according to any of the preceding embodiments and wherein the legacy game comprises an Esport game.

Embodiment 11. Apparatus according to any of the preceding embodiments and wherein the legacy game comprises a multiplayer game played by plural streamers, each of whom publishes the game as an event to her or his own viewers, thereby to provide an audience of spectators.

Embodiment 12. Apparatus according to any of the preceding embodiments and wherein the server changes the at least one aspect without requiring cooperation from the at least one Esport game.

Embodiment 13. Apparatus according to any of the preceding embodiments and wherein the user input device comprises a virtual button.

Embodiment 14. Apparatus according to any of the preceding embodiments and wherein the legacy game has a legacy modding tool and wherein game updates are typically effected by the modding tool which modifies the game's code according to the request received.

Embodiment 15. A game control method comprising:
providing software for streamers which, in conjunction with hardware processor/s, enables the streamers to play at least one legacy game generated by a game server and includes a viewing interface which allows viewers to view the streamers playing the legacy game; and
providing functionality, in the software, via which streamers enable their viewers to interact, in conjunction with hardware processor/s, with the legacy game while at least one streamer is playing the legacy game, including modifying a value of at least one input parameter controlling the game server, thereby to affect or change at least one attribute of the legacy game.

Embodiment 16. The method according to any of the preceding embodiments and wherein the legacy game comprises GTA.

Embodiment 17. The method according to any of the preceding embodiments and wherein the legacy game comprises GTA5.

Embodiment 18. The method according to any of the preceding embodiments and wherein the legacy game comprises Minecraft.

Embodiment 19. The method according to any of the preceding embodiments and wherein the legacy game comprises a Roblox game.

Embodiment 20. The method according to any of the preceding embodiments wherein the legacy game has at least one legacy modding tool aka mod, which is configured to modify the game's code by changing individual game attribute/s and wherein the providing functionality comprises presenting input option/s e.g. virtual button/s where each individual input option corresponds to an individual game attribute which the modding tool is configured to change.

Embodiment 21. A computer program product, comprising a non-transitory tangible computer readable medium having computer readable program code embodied therein, the computer readable program code adapted to be executed to implement a game control method comprising providing software for streamers which, in conjunction with hardware processor/s, enables the streamers to play at least one legacy game generated by a game server and includes a viewing interface which allows viewers to view the streamers playing the legacy game; and providing functionality, in the software, via which streamers enable their viewers to interact, in conjunction with hardware processor/s, with the legacy game while at least one streamer is playing the legacy game, including modifying a value of at least one input parameter controlling the game server, thereby to affect or change at least one attribute of the legacy game.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general-purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMS, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program, such as but not limited to a general-purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers, or other such information storage, transmission, or display devices, or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller, or processor is intended to include one or more hardware devices e.g. chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWING

FIG. 1 is a simplified flowchart illustration of a method according to an embodiment herein. The method of FIG. 1 typically comprises all or any subset of the illustrated operations, suitably ordered e.g., as shown.

Arrows between modules or operations may be implemented as APIs, and any suitable technology may be used for interconnecting functional components or modules illustrated herein in a suitable sequence or order e.g. via a suitable API/interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown.

Computational, functional, or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit Technology) or any combination thereof.

Functionality or operations stipulated as being software-implemented may, alternatively, be wholly or fully implemented by an equivalent hardware or firmware module, and vice versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include, within the scope of the embodiments of the present invention, also any software or computer program performing all or any subset of the method's operations, including a mobile application, platform, or operating system e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line, which is of any type or level or amount or category of volatility, differentiation, mutability, accessibility, addressability, capacity, performance, and energy use, and which is based on any suitable technologies such as semiconductor, magnetic, optical, paper, and others.

### DETAILED DESCRIPTION OF CERTAIN EMBODIMENTS

Certain embodiments provide a system and method adding an interactive dimension to previously passive viewing of streamed games, such as but not limited to video games and Esport games, including putting at least one aspect of at least one legacy game, which typically has legacy mod/s, in the hands of the viewer such that viewers change attributes, in real time, of a legacy game played by others; the others may be professional gamers who publish the game to their viewers e.g. as an event. Typically, the system enables viewers to change/affect/interact with games as they are played by gamers/streamers and as they are viewed by the streamers' respective audiences. The system typically puts at least one aspect of a legacy game's narrative into the hands of viewer/s.

The system herein may be integrated into any suitable platform, such as, but not limited to, a live stream recommendation platform, or a platform which enables users to view multiple live streams in a split screen, such as Lazygoat. The system herein may be provided, for example, in SAAS (software-as-a-service) form. Typically, each streamer publishes an event to their own viewers.

According to certain embodiments, viewers can interact with streamers' game/s on any streaming platform, such as but not limited to Twitch, YouTube, Facebook.

Advantages of embodiments of the system include provision of games and/or Esport events which are easy to organize, but provide a more interesting user experience/enjoyable playing time by enhancing viewer involvement, since streamers and gamers are able, via the system, to interact with viewers, and to monetize content effectively. User experience is enhanced because viewers actively interact with a legacy game, rather than merely passively observing a streamer play the game.

Advantages of embodiments of the system include convenient, efficient enhancement of legacy games by leveraging legacy open-source modifications to these legacy games which render the games interactive vis a vis viewers, who, given the legacy game as-is, were entirely passive, since a streamer, who is broadcasting the game live, is the one actually playing the game, whereas the viewers are spectators. For example, Minecraft and GTA5 are legacy games whose viewers are passive, however, according to embodiments herein, legacy modding tools such as Fivem for GTA5 may be leveraged so as to conveniently and efficiently yield an interactive game whose viewers are provided with an active, hence more satisfying, user experience, relative to conventional passive viewing of the legacy game being played by a streamer.

Advantages of embodiments of the system include leveraging of legacy games without requiring any prerequisite initial cooperation with the game server to be established offline.

Certain embodiments herein enable laymen end-users to interface with a legacy game e.g. video game, which may, optionally, be in an Esport event, in real-time, while the game is being played, by developing, offline, implementations for plural options for affecting or changing plural attributes of the game in real-time, while the game is being played, including a first option affecting or changing at least one first attribute of the game without affecting or changing at least one second attribute, and a second option affecting or changing the at least one second attribute of the game without affecting or changing the at least one first attribute, presenting the plural options to the laymen end-users via a web-service, and, responsive to each selection, via the web-service, by an individual one of the laymen end-users, of one of the options, modifying at least one attribute of the game. For example, platform apparatus herein may modify the at least one first attribute, but not the at least one second attribute, each time a layman end-user selects the first option, and may modify the at least one second attribute, but not the at least one first attribute, each time a layman end-user selects the second option.

The system includes a platform that enables a population of viewers (audience e.g.) the ability to affect or change games, such as but not limited to Esport games, played by others e.g., streamers, in real time e.g., by changing at least one game attribute/s while the streamers are playing. Control inputs provided by the viewers may even cause a player to win/lose.

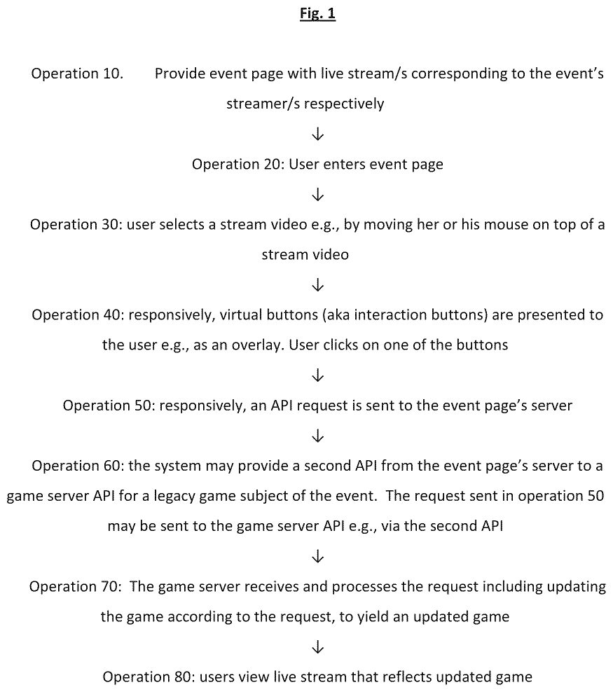

Referring now to FIG. 1, an example event flow implementing an embodiment of the invention may include all or any subset of the following operations, suitably ordered e.g., as follows:

Operation 10. Provide event page with a plurality of live streams corresponding to the event's plurality of streamers respectively (or, alternatively, there may be a single streamer). The source of each stream is a streamer broadcast platform (e.g., YouTube or Twitch or Trovo)

Operation 20: User enters event page.

Operation 30: user selects a stream video e.g., by moving her or his mouse on top of a stream video.

Operation 40: responsively, virtual buttons (aka interaction buttons) are presented to the user e.g., as an overlay. User clicks on one of the buttons.

Buttons may, respectively, correspond to game attributes that users can change. For example, in Minecraft, users might change characteristics of certain monsters or pets, such as their size or their capabilities. In gameplay of gta5 aka Grand Theft Auto V, players (e.g., streamers) complete missions where each mission is typically a linear scenario having set objectives. When in combat, e.g., firefights, in which players may use melee attacks, firearms, and explosives, attacked players can take cover, e.g., a player character may crouch behind a vehicle, to avoid incurring damage inflicted by enemies. Players may thus fight enemies, and may navigate the world e.g., by running, swimming, or driving in vehicles. Thus, game attributes to be changed may be changing one type of vehicle to another, or one type of weapon e.g. firearm for another (e.g., replacement of GTA V's sticky bomb with an exploding Samsung Galaxy Note 7), or adding or detracting from a vehicle's or weapon's functionality including adjusting weapon limits, or adding or removing objects in the GTA5 world behind which players can take cover, changing the allowable velocity of running, swimming, or driving, and so forth.

Operation 50: responsively, an API request is sent to the event page's server.

Typically, the API calls include, in a “body”, an action to be performed and attributes of that action. For example, if a call or request includes action=change−car, attribute=race−car, if it is desired to award, to a car in the game, race-car attributes which it did not have before.

Operation 60: the system may provide a second API from the event page's server to a game server API for a legacy game subject of the event. The request sent in operation 50 is sent to the game server API e.g., via the second API. For example, the legacy game may be GTA5, in which case the fivem mod (say) may be used. The game server API is then the GTA5 API.

References to APIs e.g., in operations 50, 60 may be implemented using REST APIs between client and server.

Operation 70: The game server receives and processes the request, including updating the game according to the request, to yield an updated game. Requests may be, say, “change car”, “explode car”, “make it rain”, and so forth.

According to certain embodiments, the legacy game has a modding tool or mod, and game updates are typically effected by the modding tool which modifies the game's code according to the request received. The game may be modified using the mod framework code. This may be implemented by creating a web-server that makes changes in the game using code according to REST API requests.

It is appreciated that legacy games often have a wide variety of legacy modding tools which may be installed when implementing embodiments herein, or, alternatively, mod frameworks or modding tools may be developed offline, e.g., by reverse engineering the code of the legacy game.

The terms “mod” and “modding tools” may be interchanged herewithin.

Typically, each game update, aka game change, aka “trolling”, is associated with a specific (typically pre-determined) duration or time window, during which no other change request is accepted from any viewer. According to certain embodiments, a first request may result in a first change being made (typically, the changed object state before this first change is saved), and then, after x seconds, a second request may be sent, responsive to which the state which existed before the first change, e.g., as saved, may be restored.

Typically, for each game update, only one change request is served, e.g., the first (earliest) change request. Alternatively, any other suitable selection criterion may be employed to select one change request from among plural change requests made e.g., requesting end-users may bid between them for the privilege of being the one to next update the game.

It is appreciated that providing a duration as above eliminates collisions between plural changes requested by plural users. Alternatively, any other mechanism may be employed to prevent or resolve collisions between plural changes.

Operation 80: The live stream that the users view reflects the updated game. Typically, all users see the same stream.

It is appreciated that any suitable API may be used to implement the above operations, and any suitable endpoints. Google API Client Library is an example library which is configured to interact with endpoints from a web browser.

Advantages of certain embodiments herein include that streamed game events e.g. Esport events, for example, may, become more convenient to organize and/or play and/or stream, streamers and gamers may be provided with more ways to interact with their viewers, an interactive approach may be provided for streaming games e.g. Esport games, including putting narrative in the hands of viewer/s, various ways may be provided to allow viewers to interact with a game e.g. an Esport game being played by other gamers/streamers, and user experience for viewers may be improved because viewers can affect games e.g. Esport games that are played by others in real time, and make a player win/lose by changing the game's attributes e.g., in real time.

Games herein may be played by a single player, or by plural players.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice versa. Each module, or component, or processor, may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone, or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein that impacts, in a positive manner, a problem or objectives described herein; and (b) outputting the solution.

The system may, if desired, be implemented as a network—e.g., web-based system employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients e.g., mobile communication devices, such as smartphones, may be operatively associated with, but external to the cloud.

The scope of the present invention is not limited to structures and functions specifically described herein, and is also intended to include devices which have the capacity to yield a structure, or perform a function described herein, such that, even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous, given the state or condition or data. Alternatively, or in addition, an alert may be provided to an appropriate human operator, or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in the drawing, may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawing shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawing is merely exemplary and/or appropriate for clarity of presentation, and is not intended to be limiting.

Any suitable communication may be employed between separate units herein e.g., wired data communication and/or in short-range radio communication with sensors such as cameras e.g., via Wifi, Bluetooth, or Zigbee.

It is appreciated that implementation via a cellular app as described herein is but an example and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus, whether hardware, firmware, or software, which is configured to perform, enable, or facilitate that operation, or to enable, facilitate, or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in the drawing and/or elements in the written description, may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations, or functionalities described herein, which are, for brevity, described in the context of a single embodiment, may also be provided separately, or in any suitable sub-combination, including with features known in the art. Each element e.g., operations described herein, may have all characteristics and attributes described or illustrated herein, or, according to other embodiments, may have any subset of the characteristics or attributes described herein.

It is appreciated that apps implementing any embodiment herein may include a cell app, mobile app, computer app, or any other application software. Any application may be bundled with a computer and its system software, or published separately. The term “phone” and similar used herein is not intended to be limiting, and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus, the computing device may even be disconnected from e.g., Wifi, Bluetooth, etc., but may be tethered directly or ultimately to a networked device.

1. Platform apparatus operative in conjunction with legacy games, the apparatus comprising:
a back-end server comprising a hardware processor which, responsive to at least one control parameter, changes at least one attribute, respectively, of at least one legacy game, in real-time or near realtime; and
a user interface which is configured to
present options for changing said at least one attribute to end-users viewing the legacy game being played by player/s other than the end-users;
accept inputs aka requests, from at least one of the end-users aka viewers, which select a subset of said options and,
responsively to said inputs, supply control parameters to the back-end server,
thereby to yield a platform configured to apply end-user selected options for changing said at least one attribute, to said at least one legacy game.

2. Apparatus according to claim 1 and wherein each of said options comprises a game update effected by a legacy modding tool which is associated with the legacy game, and which is configured to modify the legacy game's code, and wherein the game update to be effected by the modding tool is selected by the platform apparatus responsive to a request from an end-user.

3. Apparatus according to claim 1 and wherein said options for changing are presented to the end-users, while they are viewing the legacy game being played.

4. Apparatus according to claim 1 and wherein the options are presented as an overlay of interaction buttons where each individual button corresponds to an individual option for changing an attribute of the game.

5. Apparatus according to claim 1 and wherein a duration is defined for each option selected via the user interface, during which no other change request is accepted from any viewer.

6. Apparatus according to claim 5 and wherein, once an option for changing the game has been effected and the duration defined for said option has lapsed, only a single end-user is entitled to select a next option to be effected.

7. Apparatus according to claim 6 and wherein the single end-user is an end-user from among the end-users who selected a next option after the duration defined for said option lapsed and before any other end-user selected a next option.

8. Apparatus according to claim 6 and wherein the single end-user is an end-user from among the end-users who bid higher than other end-users, to select the next option.

9. Apparatus according to claim 1 and wherein the legacy game comprises a video game.

10. Apparatus according to claim 1 and wherein the legacy game comprises an Esport game.

11. Apparatus according to claim 1 and wherein the legacy game comprises a multiplayer game played by plural streamers, each of whom publishes the game as an event to her or his own viewers, thereby to provide an audience of spectators.

12. Apparatus according to claim 1 and wherein the server changes said at least one aspect without requiring cooperation from said at least one Esport game.

13. Apparatus according to claim 1 and wherein the user input device comprises a virtual button.

14. Apparatus according to claim 1 and wherein the legacy game has a legacy modding tool and wherein game updates are typically effected by the modding tool which modifies the game's code according to the request received.

15. A game control method comprising:
providing software for streamers which, in conjunction with hardware processor/s, enables the streamers to play at least one legacy game generated by a game server and includes a viewing interface which allows viewers to view the streamers playing the legacy game; and
providing functionality, in said software, via which streamers enable their viewers to interact, in conjunction with hardware processor/s, with the legacy game while at least one streamer is playing the legacy game, including modifying a value of at least one input parameter controlling the game server, thereby to affect or change at least one attribute of the legacy game.

16. The method according to claim 15 and wherein the legacy game comprises GTA.

17. The method according to claim 15 and wherein the legacy game comprises GTA5.

18. The method according to claim 15 and wherein the legacy game comprises Minecraft.

19. The method according to claim 15 and wherein the legacy game comprises a Roblox game.

20. The method according to claim 15 wherein the legacy game has at least one legacy modding tool aka mod, which is configured to modify the game's code by changing individual game attribute/s and wherein said providing functionality comprises presenting input option/s e.g. virtual button/s where each individual input option corresponds to an individual game attribute which the modding tool is configured to change.

21. A computer program product, comprising a non-transitory tangible computer readable medium having computer readable program code embodied therein, said computer readable program code adapted to be executed to implement a game control method comprising:
providing software for streamers which, in conjunction with hardware processor/s, enables the streamers to play at least one legacy game generated by a game server and includes a viewing interface which allows viewers to view the streamers playing the legacy game; and
providing functionality, in said software, via which streamers enable their viewers to interact, in conjunction with hardware processor/s, with the legacy game while at least one streamer is playing the legacy game, including modifying a value of at least one input parameter controlling the game server, thereby to affect or change at least one attribute of the legacy game.
